(19) United States
(12) Patent Application Publication
(10) Pub. No.: US 2008/0295019 A1
(43) Pub. Date: Nov. 27, 2008

(54) Document with Sidebars

(75) Inventors: Chris Han, Seattle, WA (US); Grzegorz Zygmunt, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/751,067

(22) Filed: May 21, 2007

(51) Int. Cl. G06F 3/048; G06F 17/00

(52) U.S. Cl. 715/781

(57) ABSTRACT

An electronic document has a sidebar object that is defined and formatted as an object within the document. The sidebar object may be presented and operate as a separate document within the main document, with individual controls such as scrolling, pagination, and zoom. A display mechanism determines display parameters for a display device and applies formatting to the document as a whole, including the sidebar object, to present the document. The sidebar object may have a second format that is applied to the sidebar object.

### BACKGROUND

Many documents in printed form have sidebars. One example of a sidebar is a highlighted section with information related to a portion of the main document, which may be a newspaper or textbook. The sidebar information may be used to highlight or explain a topic within the main document.

A sidebar may have different formatting or styles applied to the sidebar to visually offset the sidebar from a main document. For example, a sidebar may have a different background or text color to differentiate from the main body of the document. Sidebars typically are laid out and formatted for printed matter using the keen eye of a typesetter or editor to define the location, formatting, and overall look and feel of the document with the sidebar. Typically, the location and size of the sidebar may be selected to enhance the main body of the document.

Sidebars may create several problems for electronic versions of documents that are displayed on different sized screens or monitors. Because a document may be reformatted or resized for a specific window size, shape, zoom, and pixel density, the position and size of a sidebar may be difficult to present in a useful manner.

### SUMMARY

An electronic document has a sidebar object that is defined and formatted as an object within the document. The sidebar object may be presented and operate as a separate document within the main document, with individual controls such as scrolling, pagination, and zoom. A display mechanism determines display parameters for a display device and applies formatting to the document as a whole, including the sidebar object, to present the document. The sidebar object may have a second format that is applied to the sidebar object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a document with a sidebar.

FIG. 2 is a diagram of an embodiment showing a system for rendering a document with a sidebar.

FIG. 3 is a flowchart illustration of an embodiment showing a method for creating a document with a sidebar.

FIG. 4 is a flowchart illustration of an embodiment showing a method for formatting and rendering a document with a sidebar.

### DETAILED DESCRIPTION

A sidebar element in a document may be used to explain, amplify, or provide more detail for a topic in a document, often outside the scope or main flow of the main document text. Many documents, such as textbooks, newspapers, newsletters, websites, or other mechanisms may contain sidebars.

The sidebar element may be defined as a separate document within a document sidebar element may be defined within the document as any other element, such as images, tables, video clips, etc. Formatting for the sidebar may be defined within the document and applied to the sidebar with respect to the document. For example, the document formatting may define the positioning of the document on the page, the relative or absolute size of the sidebar with respect to other elements of the document, the default color, text size, text formatting, or other formatting variables for the sidebar.

The sidebar may also have formatting applied within the sidebar. The sidebar formatting may define how the sidebar elements, such as text, images, and other elements are to be laid out and presented. In many instances, a sidebar format may define different settings for the same elements. In some cases, the sidebar setting may be applied to an element, while in other cases, the document settings may be used for the element, depending on how the settings were defined. In many cases, the sidebar formatting may be defined or applied with respect to the document formatting.

The sidebar may be presented in the document as a multiple page document. Controls may be present within the sidebar for navigation as well as opening the sidebar as a separate document. By using pagination within the sidebar, the sidebar may be presented in a manner consistent with its relative importance to the main document, but contain an unlimited amount of material. For example, a sidebar element may be defined to occupy a specific portion of a document, such as 25% of a page or half of a page height for two columns of a three column layout. Even though a sidebar element may be restricted to a portion of a page, the sidebar element may contain several pages of text, images, video, audio, or other content.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

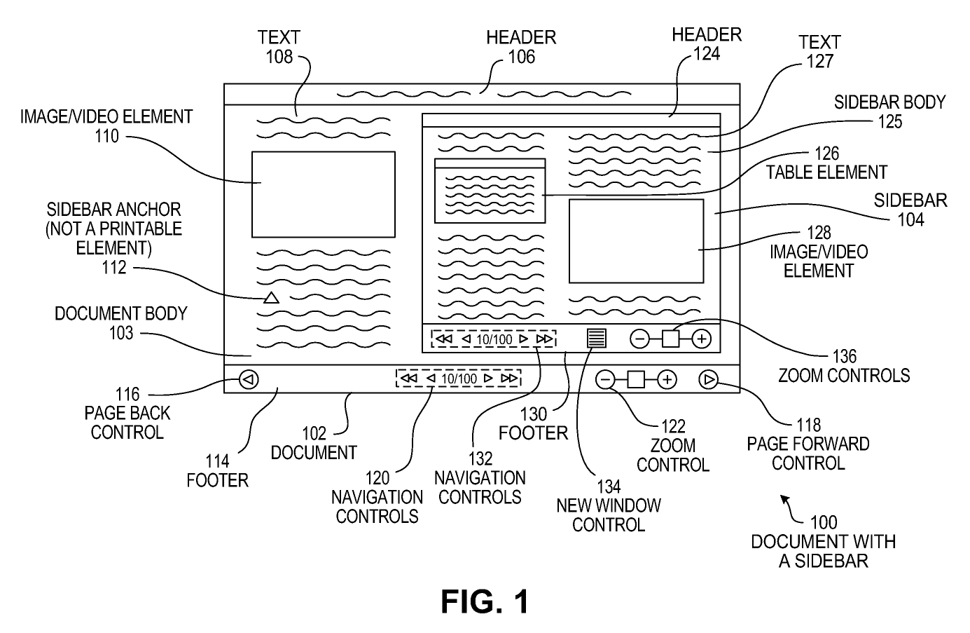

FIG. 1 is a diagram of an embodiment 100 showing a document with a sidebar element. The document 102 is shown as it may be displayed. In many embodiments, the document 102 may be defined in a format that is adaptable to different displays, from large computer monitors to a display on a mobile telephone. A document formatting and rendering engine may take the document definition and properly define the document for viewing on different displays.

The definition of the document 102 may contain content definition, such as text, tables, images, video, audio, or other content elements. The document definition may also include layout and formatting information that defines placement of elements, paragraph formatting, number of columns of text, sizing of images and other elements, foreground color, background color, font, font size, and other formatting and layout information.

The document 102 contains a sidebar 104 that may be an element within the document 102. The sidebar 104 may be formatted and positioned within the document 102 based on the formatting applied to the sidebar as defined by the document. In many cases, the sidebar 104 may be defined and formatted as another element within the document, in a similar manner as a graphic image or a video clip.

The document body 103 may have a header 106, text 108, an image or video element 110, and other content elements. Within those elements may be a sidebar anchor 112 that may define a placement for the sidebar 104 within the document 102. The anchor 112 may be a non-printable element that may be used to layout the document 102 so that the sidebar 104 may be positioned with respect to the anchor 112.

In many embodiments, the anchor 112 may be a paragraph, sentence, phrase, word, character, image, table, audio clip, video clip or other visible or invisible element with the document body 103 that is used as an anchor. The sidebar 104 may be positioned within the display in a position defined with respect to the anchor 112. The anchor 112 may act as a reference point for positioning the sidebar 104. Some embodiments may define two or more anchors that may be used to define a range in which the sidebar 104 may be positioned.

The sidebar element may be positioned within a document using many different mechanisms and definitions. The position of the sidebar 104 may be defined with respect to the anchor 112 or some other element or feature of the document. For example, a sidebar may be defined to be on the same page as an anchor. In another example, a sidebar may be positioned vertically on a page next to an anchor. In still another example, a sidebar may be positioned vertically and horizontally so that text and other elements in the document body may wrap around the sidebar. In yet another example, a sidebar may be placed on a document in a specific portion of a viewable area, without regard to an anchor, such as being positioned in the lower right corner of a page on which an anchor resides.

The sidebar element may be sized with the displayed document to occupy a specific amount of space on a page or display. For example, the sidebar 104 may be defined to occupy two columns of a three column layout or may be defined to be 2 inches wide by three inches tall. In some embodiments, the sidebar element may be defined to occupy a minimum or maximum amount of horizontal and/or vertical space on a display or page.

Each embodiment may have specific syntax and limits to a definition of a sidebar within a document. Some embodiments may enable more or less granularity or control over sidebar placement.

In many embodiments, the document 102 may be displayed in a window that may be sized on a display. In such an embodiment, the size and placement of sidebar 104 may change when the window is resized, depending on how the sidebar element was defined within the document. For example, if the sidebar element was defined to be a specific height and width, a larger sized window may present more of the text 108 or other document body elements while keeping the sidebar element 104 at the same size. If the sidebar element was defined to be a proportion of the window size, such as two column widths in a three or more column wide presentation, the sidebar element may be expanded or contracted to keep within the definition as the window is resized.

Regardless of the method of defining sidebar placement and the various options for sidebar layout, when a document is prepared for display, a sidebar may be defined within the document and positioned and formatted based on a sidebar definition within the document. After the sidebar element is positioned and formatted within the document, the sidebar element may have additional formatting that is applied to the contents of the sidebar. The additional formatting may be applied relative to the document or may supersede a formatting setting in the document.

For example, the document 102 may be rendered with a font size of 12 points that is used for a default font size throughout the document and may be applied to the sidebar element initially. In one embodiment, the sidebar element may have an initial font size that is defined to be smaller than that of the document. In such an embodiment, the font size of text inside the sidebar element may be presented using a 10 point font.

In a different embodiment, the sidebar element may have an initial font size that is defined to be 14 points, regardless of the font size of the main document. In such an embodiment, the sidebar text may be presented at 14 points, regardless if the main document text size is 8 points or 24 points.

In cases where the sidebar formatting is applied relative to the formatting of the document, a formatting and rendering engine may apply the document formatting to the sidebar element and the contents inside the sidebar element, then apply sidebar formatting to the elements inside the sidebar element.

When a document is displayed, a group of controls may be used to help navigate the document. Document 102 is shown with a page back control 116, a page forward control 118, a set of general navigation controls 120, and a zoom control 122. The various navigation controls are one method for navigating through a document. In some embodiments, a scroll bar or other navigation control may be used.

The zoom control 122 may be used to resize the contents of the document body 103 after display. For example, the zoom control 122 may be used to increase or decrease the default text size of the text 108 and, in some cases, the size of the image element 110.

In some embodiments, controls for the sidebar 104 may be different from the controls for the main document. The differences between the sidebar controls and main document controls may further highlight the separate nature of the sidebar 104. In some cases, the sidebar controls may be a different layout or have a subset of functions from the main document controls. In other cases, the sidebar controls may have a different look and feel, with color or shape differentiators between the sidebar controls and main document controls.

The sidebar element 104 may be defined with the same capabilities and in the same manner as a separate document that is presented within the document 102. The sidebar 104 may have a header 124, a body 125 that contains text 127, a table element 126, and a video or image element 128. The sidebar 104 may have a footer 130 that contains a separate set of navigation controls 132 and zoom controls 136 for the sidebar.

The various sidebar controls may enable a user to navigate through the sidebar without changing other aspects of the main document. For example, a user may use the sidebar zoom control 136 to increase the text size of the sidebar contents and the navigation controls 132 to scroll through the various pages of the sidebar contents. In using the sidebar controls, other areas of the document 102 outside the sidebar 104 may be unaffected and unchanged.

The sidebar 104 may also have a new window control 134 that may create a new window on a display that contains the sidebar 104 as a separate document.

The sidebar 104 may be defined and stored as a separate document that is linked to the document 102 and displayed within the sidebar element. In other embodiments, the sidebar 104 may be encapsulated or stored inside the document 102.

The sidebar 104 may be displayed with multiple pages of information that may be navigated using a separate navigation controls for the sidebar. The sidebar 104 may be presented inside the document 102 as an element within the document 102 such as an image or video clip, so that the look and feel of the document 102 may be preserved, regardless of the length and complexity of the sidebar 104. Such a system may enable a sidebar 104 to be sized, positioned, and presented by an author appropriately for the situation.

For example, a sidebar may be added to a document to add background information on a minor topic covered by the main portion of a document. An author may wish the sidebar to have a minor impact in the look and feel of the main document so that the theme of the main document is kept in focus. In such a case, the sidebar may be defined to a small area within the document so that the sidebar does not detract from the main emphasis of the document. However, the sidebar may have a large amount of data, text, images, or other information that can be viewed through the sidebar using the various controls.

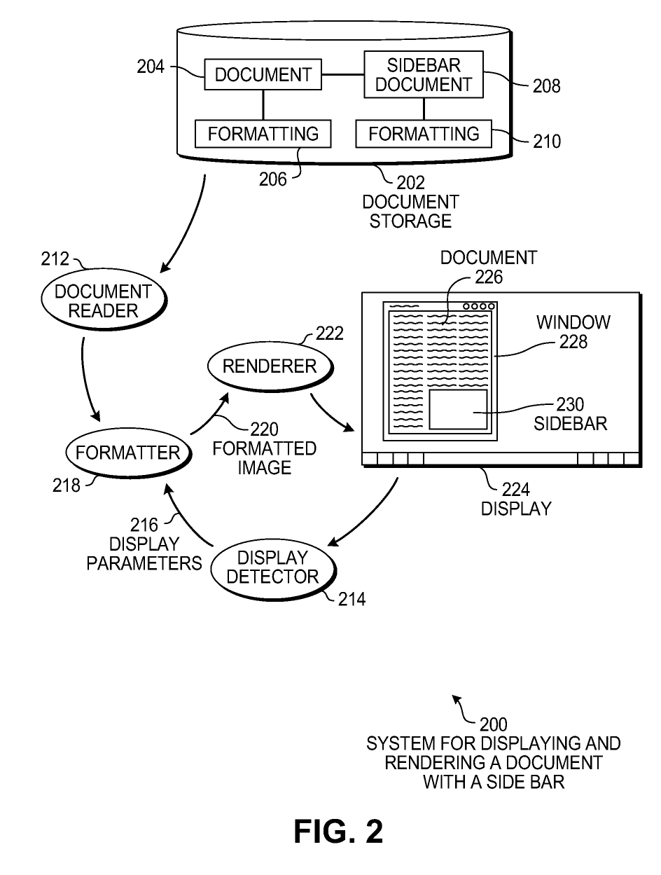

FIG. 2 is a diagram illustration of an embodiment 200 showing a system for displaying and rendering a document with a sidebar. The document with a sidebar is read, formatted, and rendered on a display. The formatting may be done at the time of display, using the format definitions defined beforehand and display parameters from the current display. The formatting may allow a document to be rendered on many different displays, from large displays with many pixels to small displays on handheld devices with limited display capability.

A document store 202 may contain a document 204 with document formatting 206 and a sidebar document 208 with associated formatting 210. The document 204 with its formatting 206 may be defined in any appropriate manner, including markup languages such as HTML, XML, XAML, or other languages. In some embodiments, the formatting 206 may be defined in one or more separate files from the document 204, such as a style sheet. In other embodiments, the some or all of the formatting 206 may be incorporated into a file containing the document contents 204.

The sidebar document 208 may be a separate document from the document 204 and may be created and defined using similar tools and stored in similar formats. In some embodiments, the sidebar document 208 may be linked to the document 204 through a reference within the document 204, with the document 204 and sidebar 208 being separate files. In other embodiments, the sidebar 208 may be incorporated into the same file as document 204.

The sidebar formatting 210 may be the same or different from the document formatting 206. In many cases, the sidebar formatting 210 may use the same syntax and definitions, while in other embodiments, a different language or a subset or superset of the formatting language used to describe the document formatting 206 may be used.

A document reader 212 may read the document data from the data store 202 and pass the data to a formatter 218. The formatter 218 may also receive display parameters 216 from a display detector 214 to produce a formatted image 220. The formatted image 220 may be rendered by the renderer 222 to produce the document 226 on the display 224.

The formatter 218 may apply the document formatting 206 and sidebar formatting 210 to fit the display parameters 216. The formatter 218 may apply the formatting in two passes: a first pass for the document formatting 206 and a second pass for the sidebar formatting 210.

The display detector 214 may determine the size, shape, pixel density, or other parameters associated with the display 224 for the rendered image. In some instances, the document 226 may be displayed on a full screen of the display 224. In other instances, the document 226 may be displayed in a portion of the display 224, such as a window 228.

The displayed document 226 may be displayed with the sidebar 230 which may be shown on a portion of the window 228. The layout and format of the document 226 and sidebar 230 may be different for different configurations of the window 228 or display 224. The look and feel of the document 226 may be defined by the formatting 206 and may be consistent over a range of configurations of windows 228 and displays 224.

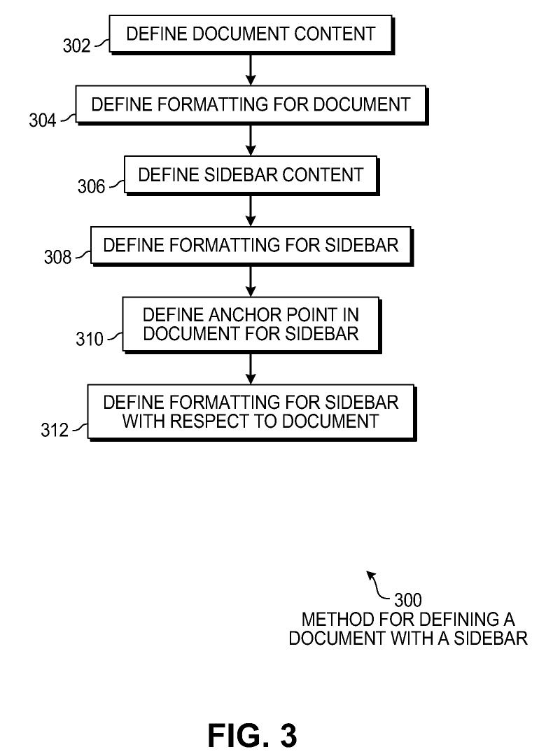

FIG. 3 is a flowchart illustration of an embodiment 300 of a method for defining a document with a sidebar. Embodiment 300 is a method by which a document and a sidebar may be separately defined and formatted, then joined using an anchor and a sidebar element to define a document with a sidebar.

Document content may be defined in block 302 and formatting defined in block 304. In some instances, content and formatting may be defined in parallel. In other instances, a predefined formatting definition may be used. In such an instance, content may be defined within a structure of the formatting or the formatting may be applied after the content is created.

The formatting may apply specific visual or layout characteristics to different content elements. For example, different text elements may have formatting applied for fonts, paragraph layout, positioning restraints, or other features. An image element may have formatting applied to define borders, captions, positioning with respect to text elements, as well as size of the image element. Each element type may have specific visual or layout characteristics that may be applied to the element.

In block 306, sidebar content may be defined and formatting defined in block 308. In some embodiments, the sidebar content and formatting may be defined separately from the content and formatting of the document in blocks 302 and 304. In other embodiments, the sidebar content may be defined within the content of the document.

An anchor point is defined in the document in block 310. In some embodiments, the sidebar content and formatting may be linked to the anchor point. The link may be a reference to a file that contains the sidebar content and formatting. Such a link may be a Uniform Resource Locator (URL) that may refer to a file or set of files located over a network or the Internet.

The formatting of the sidebar with respect to the document may be defined in block 312. Such formatting may include defining the visual and layout aspects of the sidebar element, such as the color, captions, size, and placement of the sidebar within the document.

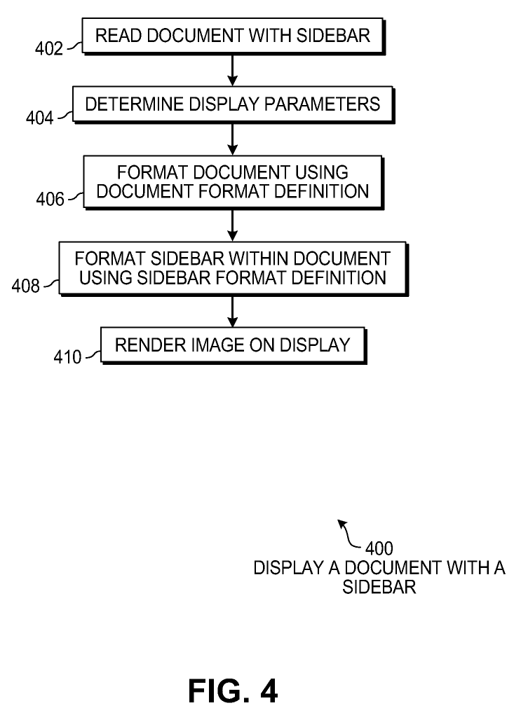

FIG. 4 is a flowchart illustration of an embodiment 400 showing a method for displaying a document with a sidebar. Embodiment 400 illustrates a two pass formatting method that may be applied to sidebar contents when rendering the sidebar on a display.

The document with sidebar is read in block 402. In some instances, the document and sidebar together with formatting may be stored in several files or locations. In other instances, the document, sidebar, and associated formatting may be included in a single file or location.

Display parameters for the rendered image are determined in block 404. In many cases, a display driver or other mechanism may be queried to determine display characteristics. The display characteristics may include a window size or other definition of a portion of the display allocated for rendering the document.

The document may be formatted using the document format definition in block 406. While formatting the document, a sidebar element may be laid out and positioned. In some instances, a default formatting may be defined for the contents of a sidebar. In general, the formatting of block 406 may not include formatting the sidebar contents, but may include applying visual and layout formatting to the element in which the sidebar contents will be rendered.

The sidebar contents may be formatted in block 408 using the sidebar format definitions. In some instances, the sidebar formatting may add, remove, or replace one or more aspects of visual or layout formatting for the sidebar contents. For example, the document formatting may define a default font, font size, and font color for the document. The sidebar formatting may change the font color and may increment the font size to a size larger than the default. The sidebar formatting may not define any changes to the font and thus the sidebar text elements may be rendered with the font defined in the document formatting of block 406.

After formatting is applied based in blocks 406 and 408 based on the display parameters 404, the image is rendered on a display in block 410.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
reading a document, said document comprising a sidebar object and a document format definition, said sidebar object comprising a sidebar object definition;
determine display parameters about a display;
formatting said document using said display parameters and said document format definition, said document format definition being applied to said sidebar object;
formatting said sidebar object using said sidebar format definition; and
rendering said document within a first display object on said display.

2. The method of claim 1, said sidebar object comprising at least one of a group composed of: text, video, audio, and an image.

3. The method of claim 1, said sidebar object comprising a header.

4. The method of claim 1, said sidebar object having an anchor defined in said document.

5. The method of claim 1, said first display object comprising a window.

6. The method of claim 1, said first display object comprising a full screen display.

7. The method of claim 1 further comprising:
controlling said sidebar object independently from said document.

8. The method of claim 7, wherein said controlling comprises at least one of a group composed of: page navigation, zooming, panning, and scrolling.

9. The method of claim 1 further comprising:
opening said sidebar object in a second display object.

10. A computer readable medium comprising computer executable instructions adapted to perform the method of claim 1.

11. A system comprising:
a document reader adapted to read a document, said document comprising a sidebar object and a document format definition, said sidebar object comprising a sidebar format definition;
a display detector adapted to determine display parameters about a display;
a formatter adapted to:
format said document using said display parameters and said document format definition, said document format definition being applied to said sidebar object; and
format said sidebar object using said sidebar format definition; and
a renderer adapted to render said document within a first display object on said display.

12. The system of claim 11 further comprising:
a controller adapted to perform controlling functions on said sidebar object.

13. The system of claim 12, said controlling functions comprising at least one of a group composed of: page navigation, zooming, panning, and scrolling.

14. The system of claim 12, said controlling functions being applied to said sidebar object independently of said document.

15. The system of claim 12, said sidebar object comprising a header.

16. The system of claim 12, said sidebar object having an anchor defined in said document.

17. An electronic document comprising:
a document body;
a sidebar object comprising:
an anchor within said document body; and
a sidebar format definition;
a document format definition adapted to be applied to said document body and said sidebar object.

18. The electronic document of claim 17, said sidebar object further comprising a header.

19. The electronic document of claim 17, said sidebar object further comprising controls adapted to perform controlling operations on said sidebar object.

20. The electronic document of claim 19, said controlling operations comprising at least one of a group composed of: page navigation, zooming, panning, and scrolling.
